(19) United States
(12) Patent Application Publication
(10) Pub. No.: US 2017/0276776 A1
(43) Pub. Date: Sep. 28, 2017

(54) COMMUNICATION APPARATUS, METHOD OF CONTROLLING THE SAME, AND STORAGE MEDIUM

(71) Applicant: CANON KABUSHIKI KAISHA, Tokyo (JP)

(72) Inventor: Morikazu Ito, Yokohama-shi (JP)

(21) Appl. No.: 15/455,936

(22) Filed: Mar. 10, 2017

(30) Foreign Application Priority Data
Mar. 24, 2016 (JP) 2016-060903

(51) Int. Cl. G01S 11/06

(52) U.S. Cl. CPC G01S 11/06; H04W 4/008

(57) ABSTRACT

A table defining relationships between radio field intensities of radio waves received from an external apparatus and distances to the external apparatus is held. Radio field intensities of radio waves received from the external apparatus are stored. A first radio field intensity and a second radio field intensity are respectively calculated as representative values of high radio field intensities and low radio field intensities from the stored radio field intensities. A distance to the external apparatus is obtained based on the held table and one or both of the first radio field intensity and the second radio field intensity.

### BACKGROUND OF THE INVENTION

Field of the Invention

The present invention relates to a communication apparatus, a method of controlling the same, and a storage medium.

Description of the Related Art

An increasing number of image forming apparatuses, such as multi-function peripherals and printers, are equipped with wireless functions that use a wireless LAN, Bluetooth Low Energy (BLE), and so forth. To perform printing using these image forming apparatuses, a user wirelessly communicates with the image forming apparatuses via a mobile terminal, pairs the mobile terminal to the image forming apparatuses based on information included in communicated information, and then issues various instructions for printing and the like from the mobile terminal to the image forming apparatuses.

The properties of intensities of radio waves used in wireless communication are such that the intensities typically attenuate in inverse proportion to the square of a distance, therefore, a distance between a mobile terminal and an image forming apparatus can be specified based on the intensities of radio waves received by the mobile terminal (radio field intensities). Various types of processing can be executed between the mobile terminal and the image forming apparatus in accordance with the distance thus specified. Examples of such processing include processing for searching for the image forming apparatus from the mobile terminal, and processing for feeding information of print data and the like from the mobile terminal to the image forming apparatus.

For example, Japanese Patent Laid-Open No. 2012-173070 describes conventional technology of specifying a distance between an image forming apparatus and a mobile terminal. According to this technology, the band of a signal transmitted from an access point is varied in receiving the signal, its received signal strength indicator (RSSI) is calculated, and an index of a radio wave environment is calculated from the RSSI. Furthermore, this index calculation is carried out for each access point, and the access points are weighted in specifying the positions of the access points.

When a distance between an image forming apparatus and a mobile terminal is specified based on radio waves emitted by a BLE chip provided in the image forming apparatus and on the radio field intensities of radio waves received by the mobile terminal, the radio field intensities of the received radio waves are not constant with distance, and may be high or low even if the positions of the apparatus and terminal are fixed. Contributing factors include interference between radio waves, reflection off the walls and floor, and so forth. This gives rise to the problem that the received radio waves may have unintended radio field intensities at some timings of sampling of radio field intensities, and an accurate distance cannot be specified from the radio field intensities of the received radio waves.

### SUMMARY OF THE INVENTION

An aspect of the present invention is to eliminate the above-mentioned problems with conventional technology.

A feature of the present invention is to provide a technique for accurately specifying a distance to an external apparatus that emitted wireless radio waves based on wireless radio waves that have been received.

According to a first aspect of the present invention, there is provided a communication apparatus, comprising: a memory device that stores a set of instructions; and at least one processor that executes the instructions to: hold a table defining relationships between radio field intensities of radio waves received from an external apparatus and distances to the external apparatus, store radio field intensities of radio waves received from the external apparatus in a memory, calculate at least a first radio field intensity and a second radio field intensity from the radio field intensities stored in the memory, and obtain a distance to the external apparatus based on the table and one or both of the first radio field intensity and the second radio field intensity, wherein in the calculation, the first radio field intensity and the second radio field intensity are respectively calculated as representative values of high radio field intensities and low radio field intensities included among the radio field intensities stored in the memory.

According to a second aspect of the present invention, there is provided a method of controlling a communication apparatus that specifies a distance to an external apparatus based on radio field intensities of radio waves received from the external apparatus, the method comprising: storing radio field intensities of radio waves received from the external apparatus in a memory; calculating at least a first radio field intensity and a second radio field intensity from the radio field intensities stored in the memory; and obtaining the distance to the external apparatus based on a table and one or both of the first radio field intensity and the second radio field intensity, the table defining relationships between radio field intensities of received radio waves and distances, wherein in the calculating, the first radio field intensity and the second radio field intensity are respectively calculated as representative values of high radio field intensities and low radio field intensities included among the radio field intensities stored in the memory.

Further features of the present invention will become apparent from the following description of exemplary embodiments with reference to the attached drawings.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 depicts a view illustrating an example of a configuration of a network including an image forming apparatus according to a first embodiment.

FIG. 2 is a block diagram for describing a configuration of the image forming apparatus according to the first embodiment.

FIG. 3 is a block diagram for describing a configuration of a mobile terminal according to the first embodiment.

FIG. 4 is a block diagram for describing software configuration of the image forming apparatus and the mobile terminal according to the first embodiment, and a structure of data managed by the software.

FIGS. 5A and 5B depict views respectively showing examples of distances between the mobile terminal and the image forming apparatus according to the first embodiment.

FIG. 6 depicts a view showing examples of relationships between distances from the mobile terminal to the image forming apparatus according to the first embodiment and radio field intensities.

FIG. 7 is a flowchart for describing processing in which the mobile terminal according to the first embodiment receives wireless radio waves emitted by an external apparatus and obtains a distance to the external apparatus based on their radio field intensities.

FIGS. 8A to 8C depict views respectively illustrating examples of relationships between distances from the mobile terminal according to the first embodiment to an apparatus that emitted radio waves and the first and second radio field intensities.

FIG. 9 is a flowchart for describing processing in which the mobile terminal according to the first embodiment receives wireless radio waves emitted by an external apparatus that is within an immediate range thereof and obtains a distance to the external apparatus based on their radio field intensities.

FIG. 10 depicts a view illustrating an example of a menu screen displayed on an operation unit of the mobile terminal according to the first embodiment.

FIG. 11 is a flowchart for describing processing in which a mobile terminal according to a second embodiment of the present invention receives wireless radio waves emitted by an external apparatus and obtains a distance to the external apparatus based on their radio field intensities.

### DESCRIPTION OF THE EMBODIMENTS

Embodiments of the present invention will be described hereinafter in detail, with reference to the accompanying drawings. It is to be understood that the following embodiments are not intended to limit the claims of the present invention, and that not all of the combinations of the aspects that are described according to the following embodiments are necessarily required with respect to the means to solve the problems according to the present invention.

### First Embodiment

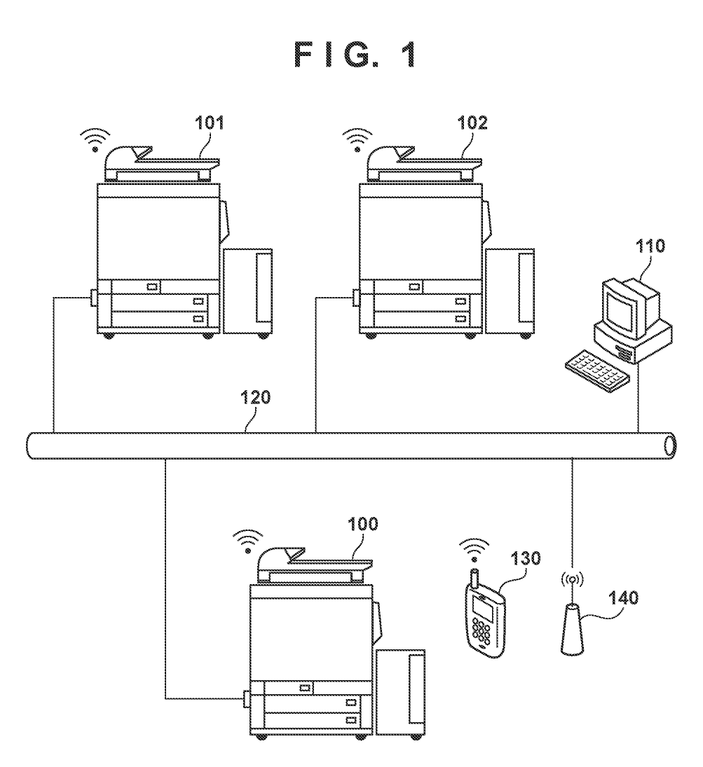

FIG. 1 depicts a view illustrating an example of a configuration of a network including an image forming apparatus 100 according to a first embodiment of the present invention.

Image forming apparatuses 100, 101, 102 are connected to a network 120, and can communicate with external apparatuses, such as a PC 110 and a mobile terminal 130, via the network 120. The image forming apparatuses 100 to 102 respectively have a wireless communication function, and can perform transmission and reception via a wireless LAN and Bluetooth®. The PC 110 transmits print data to any one of the image forming apparatuses 100 to 102 via the network 120. The mobile terminal 130 can connect to any one of the image forming apparatuses 100 to 102 via an access point 140 or via direct wireless communication, and perform printing by transmitting print data to the image forming apparatus. The mobile terminal 130 can also receive radio waves transmitted from the image forming apparatuses 100 to 102, analyze the contents of the radio waves, and execute various types of processing in accordance with the contents. Once the image forming apparatuses 100 to 102 have received print data, they execute print processing based on the received print data. Although the following description focuses on the image forming apparatus 100, it goes without saying that this description similarly applies to other image forming apparatuses.

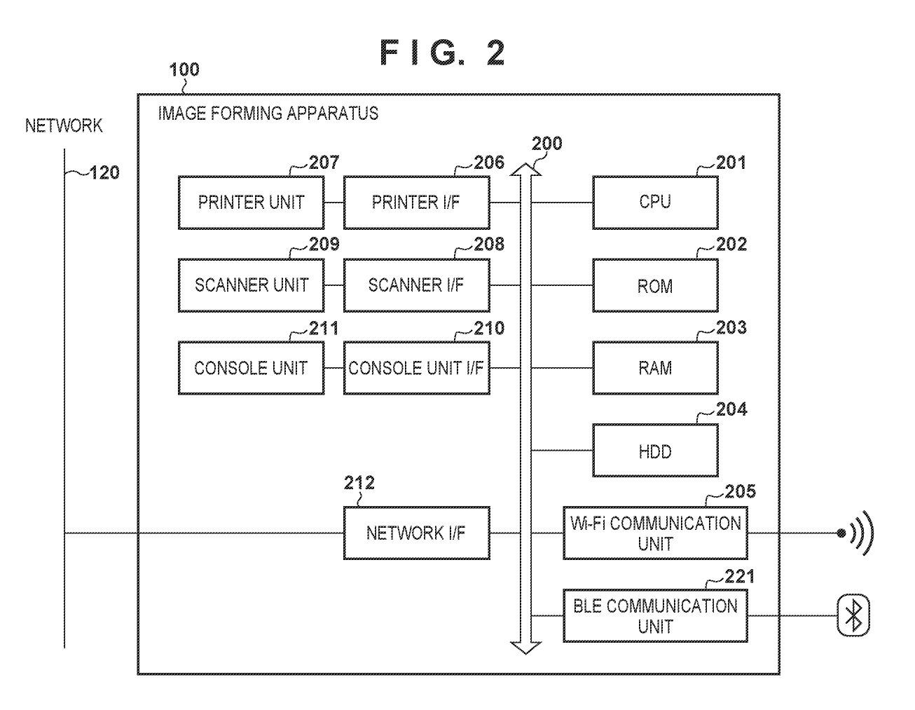

FIG. 2 is a block diagram for describing a configuration of the image forming apparatus 100 according to the first embodiment. Although the image forming apparatus 100 according to the first embodiment is envisaged as a multi-function peripheral, it may be a printer without a scanner function.

A CPU 201 controls the operations of the image forming apparatus 100 by executing a boot program stored in a ROM 202, reading out control programs stored in an HDD 204, deploying the control programs to a RAM 203, and executing the deployed control programs. The CPU 201 is connected to other components via a bus 200. The ROM 202 stores the boot program and various types of data. The RAM 203 is used as a temporary storage area, such as a main memory and a working area, for the CPU 201. The HDD 204 stores the control programs and various types of data, such as print data and scan image data. Although it will be assumed that one CPU 201 executes various types of processing of later-described flowcharts in the image forming apparatus 100, other modes can be implemented. For example, a plurality of CPUs may execute various types of processing of later-described flowcharts in coordination with one another.

A Wi-Fi communication unit 205 implements wireless communication with the mobile terminal 130. The Wi-Fi communication unit 205 may implement direct wireless communication between the image forming apparatus 100 and the mobile terminal 130 without intervention of a relay apparatus, such as the access point. A BLE communication unit 221 implements wireless communication with the mobile terminal 130. The mobile terminal 130 measures a distance between the mobile terminal 130 and the image forming apparatus 100 in accordance with the radio field intensities of radio waves received via BLE.

A printer I/F 206 establishes connection between a printer unit 207 and the bus 200. The printer unit 207 performs printing on a sheet based on, for example, print data received from the external apparatuses or image data generated by a scanner unit 209. A scanner I/F 208 establishes connection between the scanner unit 209 and the bus 200. The scanner unit 209 implements a copy function by reading an original, generating image data corresponding to an image of the original, and outputting the generated image data to the printer unit 207. The generated image data can be stored in the HDD 204. A console unit I/F 210 establishes connection between a console unit 211 and the bus 200. The console unit 211 includes a display unit with a touchscreen function and a keyboard, displays various console screens, and outputs, to the bus 200, instructions issued by a user via the console unit 211 and information input from the console unit 211. A network I/F 212 is connected to the network 120, and implements communication with the external apparatuses on the network 120. The network I/F 212 receives print data transmitted from the external apparatuses, and performs printing by outputting the received print data to the printer unit 207 under control of the CPU 201.

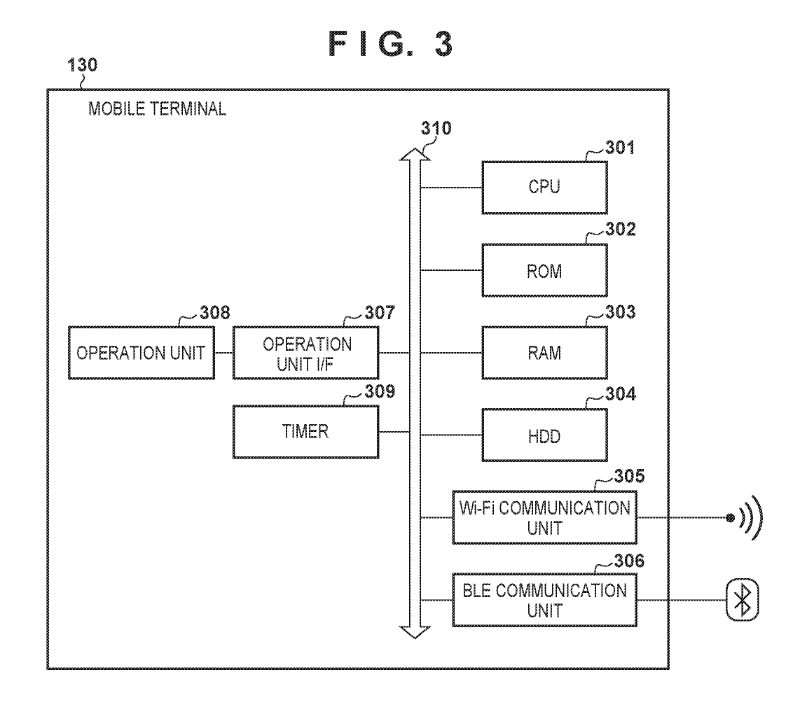

FIG. 3 is a block diagram for describing a configuration of the mobile terminal 130 according to the first embodiment.

A CPU 301 executes various types of processing for controlling the operations of the mobile terminal 130 by executing a boot program stored in a ROM 302 and reading out programs stored in an HDD 304. The CPU 301 is connected to other components via a bus 310. The ROM 302 stores programs and various types of data. The RAM 303 is used as a temporary storage area, such as a main memory and a working area, for the CPU 301. The HDD 304 stores control programs and various types of data, such as image data.

A Wi-Fi communication unit 305 implements wireless communication with the image forming apparatus 100. The Wi-Fi communication unit 305 may implement direct wireless communication between the image forming apparatus 100 and the mobile terminal 130 without intervention of a relay apparatus, such as the access point 140. A BLE communication unit 306 implements wireless communication with the image forming apparatus 100. A distance between the mobile terminal 130 and the image forming apparatus 100 is measured in accordance with the radio field intensities of radio waves received by the mobile terminal 130 via BLE. An operation unit I/F 307 establishes connection between an operation unit 308 and the bus 310. The operation unit 308 includes a display unit with a touchscreen function, and displays various operation screens. A user can input instructions and information to the mobile terminal 130 via the operation unit 308. A timer 309 clocks a designated time period in compliance with an instruction from the CPU 301, and if timeout occurs, notifies the CPU 301 of the same using an interrupt and the like.

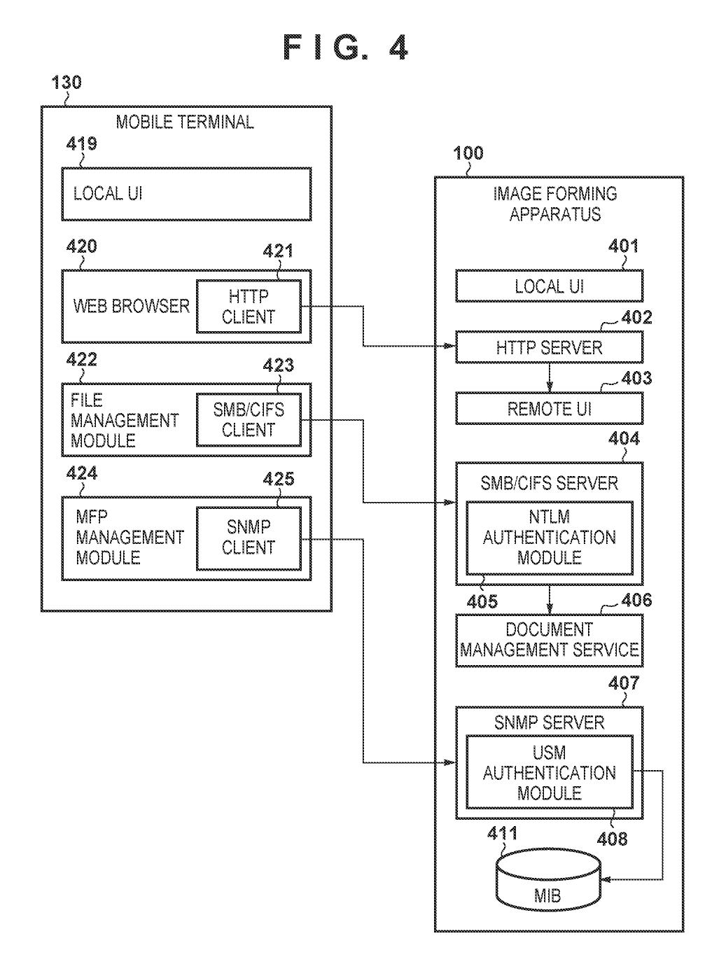

FIG. 4 is a block diagram for describing software configuration of the image forming apparatus 100 and the mobile terminal 130 according to the first embodiment, and a structure of data managed by the software. Arrows in FIG. 4 indicate callers and callees of functions in main use cases. A description is now given of the functions of the software and data managed by the software.

A local user interface (UI) 401 of the image forming apparatus 100 displays a user interface that can be operated by a user on the console unit 211 to provide the functions of the image forming apparatus 100 to the user.

The mobile terminal 130 includes, for example, the following items of software: a local UI 419, a web browser 420, a file management module 422, and an MFP management module 424. The local UI 419 displays a user interface that can be operated by a user on the operation unit 308 to provide the functions of the mobile terminal 130 to the user. For example, the user of the mobile terminal 130 can check device information included in wireless information received by the Wi-Fi communication unit 305 using the user interface of the local UI 419. The web browser 420 functions as an HTTP client 421 for communicating with an HTTP server 402 of the image forming apparatus 100. Upon receiving a request from the web browser 420, the HTTP server 402 of the image forming apparatus 100 calls a remote UI 403 of the image forming apparatus 100. The remote UI 403 of the image forming apparatus 100 provides a user interface described in HTML to the user operating the web browser 420. The HTTP server 402 returns the HTML obtained from the remote UI 403 to the web browser 420 in response to the request from the web browser 420.

The file management module 422 functions as an SMB/CIFS client 423 for communicating with an SMB/CIFS server 404 of the image forming apparatus 100. The SMB/CIFS server 404 includes an NTLM authentication module 405 that processes NT LAN Manager (NTLM) authentication protocols for Windows. Upon receiving a request for, for example, browsing or storage of a file from the file management module 422, the SMB/CIFS server 404 calls a document management service 406. The document management service 406 has a function of browsing or updating electronic documents (files with such extensions as PDF, JPEG, NG, and DOC) stored in the HDD 204, storing new files, and so forth.

The MFP management module 424 functions as an SNMP client 425 for accessing a management information base (MIB) 411 through access to an SNMP server 407 of the image forming apparatus 100. The SNMP server 407 includes a USM authentication module 408 that processes user authentication protocols specified by the User-based Security Model (USM) of SNMP version 3. Upon receiving an access request from the MFP management module 424, the SNMP server 407 of the image forming apparatus 100 references or sets data stored in the MIB 411.

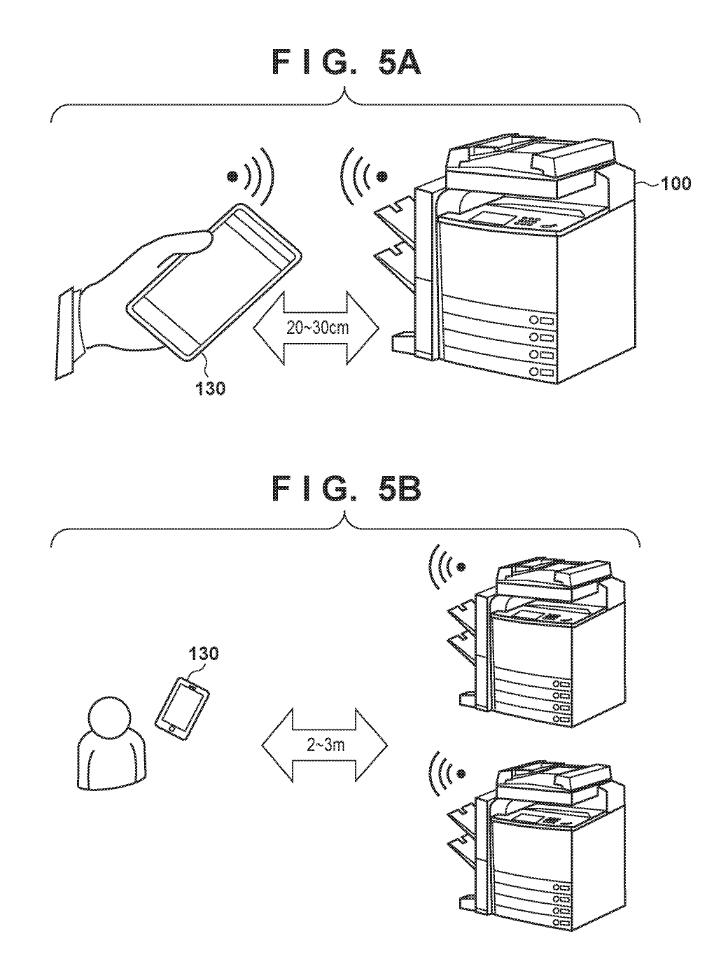

FIGS. 5A and 5B depict views illustrating examples of distances between the mobile terminal 130 and the image forming apparatus 100 according to the first embodiment.

FIG. 5A depicts a case in which E-mail addresses or document data stored in the mobile terminal 130 is transmitted to the image forming apparatus 100. In this case, as data needs to be accurately transmitted to the desired image forming apparatus 100, communication is performed only within an immediate range of 20 cm to 30 cm to prevent erroneous transmission.

On the other hand, FIG. 5B depicts a case in which the mobile terminal 130 searches for an image forming apparatus via BLE. In this case, as it is necessary to search for a somewhat distant image forming apparatus, communication is performed within a near range of approximately 2 m to 3 m.

The following describes the embodiment based on these examples.

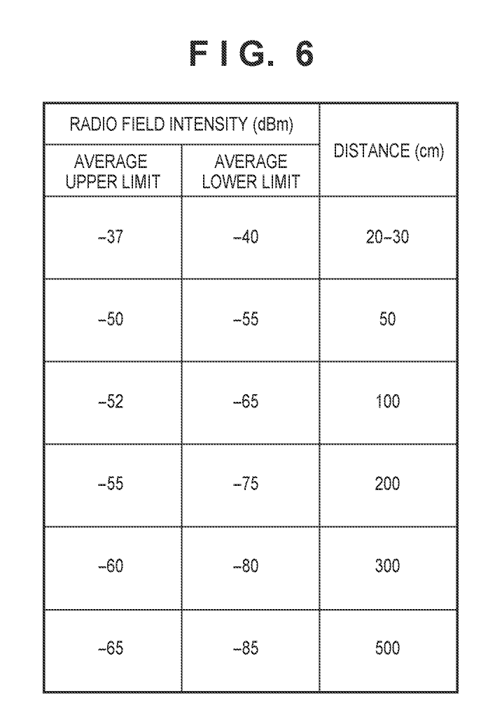

FIG. 6 depicts a view showing examples of relationships between distances from the mobile terminal 130 to an image forming apparatus according to the first embodiment and radio field intensities.

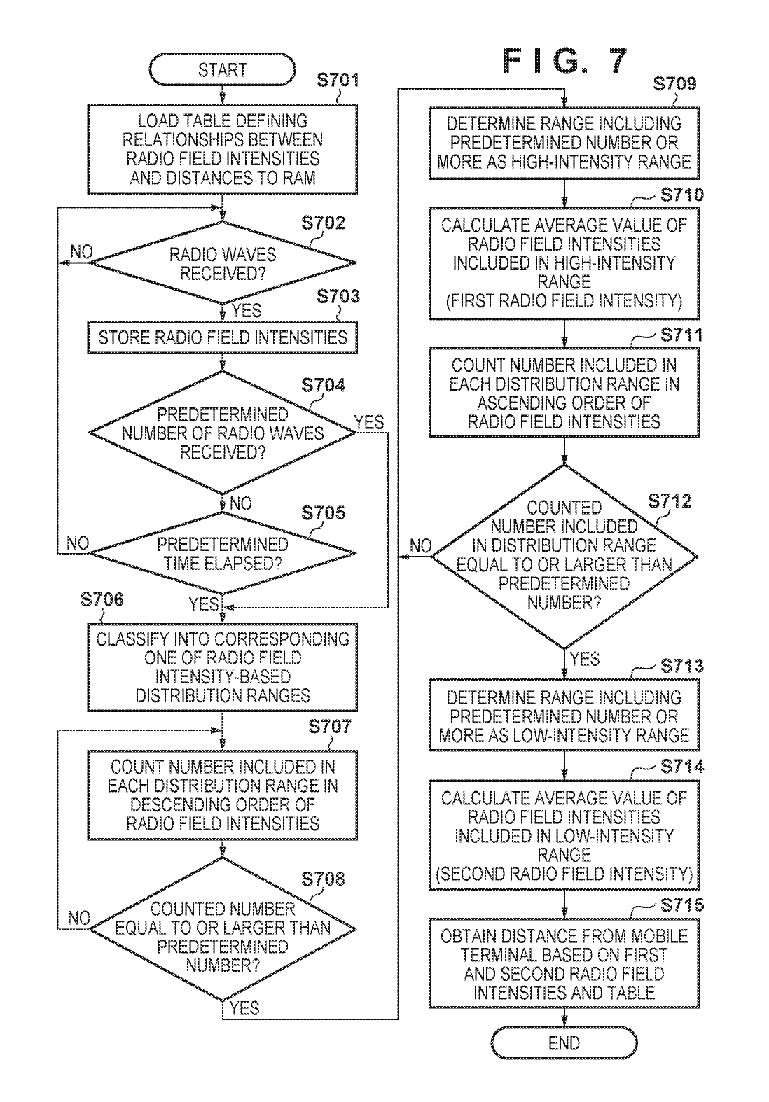

These examples are shown in the form of a table indicating specific relationships between distances from the mobile terminal 130 to an image forming apparatus and average upper and lower limits of radio field intensities. A method of calculating the average upper and lower limits and the like will be described with reference to FIG. 7 and subsequent figures. This table is held in, for example, the HDD 304.

FIG. 7 is a flowchart for describing processing in which the mobile terminal 130 according to the first embodiment receives wireless radio waves emitted by an external apparatus and obtains a distance to the external apparatus based on their radio field intensities. A program that causes the CPU 301 to execute the processing of this flowchart is stored in the ROM 302 or the HDD 304, and the processing is implemented by the CPU 301 deploying the program to the RAM 303 and executing the deployed program.

When this processing is started, the CPU 301 first loads the table defining relationships between radio field intensities and distances (see FIG. 6), which is stored in the HDD 304, to the RAM 303 in step S701. Note that this process of deploying the table to the RAM 303 is unnecessary if, for example, the table is stored in the ROM 302 when referenced. Next, the processing proceeds to step S702 and the CPU 301 determines whether or not wireless radio waves have been received from an external apparatus. If the wireless radio waves have been received, the processing proceeds to step S703 and the CPU 301 stores their radio field intensities to the RAM 303. Next, the processing proceeds to step S704 and the CPU 301 determines whether or not the number of radio field intensities thus stored has reached a predetermined number necessary for obtaining a distance. It will be assumed herein that the predetermined number is 30, for example. If the CPU 301 determines in step S704 that it has not stored the predetermined number of radio field intensities of received radio waves, the processing proceeds to step S705 and the CPU 301 determines whether or not a predetermined time period (e.g., 30 seconds) has elapsed since the start of the processing of FIG. 7. To make this determination, the time is clocked by the aforementioned timer 309. If it is determined that the predetermined time period has elapsed, the processing proceeds to step S706, if not, the processing proceeds to step S702. The process of step S705 is intended to prevent an extreme delay in the processing of the mobile terminal 130 caused by an increase in the time taken to store the predetermined number of radio field intensities.

If it is determined in step S704 that the predetermined number of radio field intensities have been stored, or if it is determined in step S705 that the predetermined time period has elapsed, the processing proceeds to step S706 and the CPU 301 classifies each of the radio field intensities of received radio waves into a corresponding one of intensity-based distribution range. This classification into distribution ranges can be performed by, for example, classifying standard deviations 3σ to −3σ in increments of 0.5σ. Next, the processing proceeds to step S707 and the CPU 301 counts the number of radio waves included in each distribution range, starting with a distribution range with highest radio field intensities. Then, the processing proceeds to step S708 and the CPU 301 determines whether or not the counted number is equal to or larger than a predetermined number (e.g., three). If the counted number is not equal to or larger than the predetermined number, the processing proceeds to step S707 to count the number of radio field intensities included in a distribution range with next highest radio field intensities, and then proceeds to step S708. If the counted number of radio field intensities included in the distribution range is equal to or larger than the predetermined number in step S708, the processing proceeds to step S709, and the CPU 301 determines that this distribution range is a range with high radio field intensities, and the processing proceeds to step S710. In step S710, the CPU 301 calculates an average value of the radio field intensities included in this distribution range as one example of a representative value of such radio field intensities, and uses the calculated average value as a first radio field intensity.

Next, the processing proceeds to step S711 and the CPU 301 counts the number of radio waves included in each distribution range, starting with a distribution range with lowest radio field intensities, conversely to the aforementioned step S707. Then, the processing proceeds to step S712 and the CPU 301 determines whether or not the counted number is equal to or larger than a predetermined number (e.g., three). If the counted number is not equal to or larger than the predetermined number, the processing proceeds to step S711 to count the number of radio field intensities included in a distribution range with next lowest radio field intensities, and then the processing proceeds to step S712. If the counted number of radio field intensities included in the distribution range is equal to or larger than the predetermined number in step S712, the processing proceeds to step S713, and the CPU 301 determines that this distribution range is a range with low radio field intensities, and the processing proceeds to step S714. In step S714, the CPU 301 calculates an average value of the radio field intensities included in this distribution range as one example of a representative value of such radio field intensities, and uses the calculated average value as a second radio field intensity. Next, the processing proceeds to step S715 and the CPU 301 obtains a distance between the mobile terminal 130 and the apparatus that emitted wireless radio waves with reference to the first radio field intensity obtained in step S710, the second radio field intensity obtained in step S714, and the table loaded to the RAM 303 in step S701. Thereafter, the present processing is ended.

As described above, the mobile terminal 130 according to the first embodiment specifies a distance between the mobile terminal 130 and the apparatus that emitted radio waves based on the average value of radio field intensities included in a range with received radio waves having high radio field intensities, and on the average value of radio field intensities included in a range with received radio waves having low radio field intensities. In this way, a distance between the mobile terminal and the apparatus that emitted radio waves can be obtained accurately.

If timeout occurs without receiving the predetermined number of radio waves in step S704, the predetermined number used in steps S708 and S712 is reduced to a value smaller than three, and then whether the number of radio field intensities included in each distribution range is equal to or larger than the predetermined number is determined. This measure is taken, for example, when the number of radio field intensities obtained in a distribution range with high radio field intensities and the number of radio field intensities obtained in a distribution range with low radio field intensities are one each, or when one or more radio field intensities have been obtained in only one of a distribution range with high radio field intensities and a distribution range with low radio field intensities, and so forth.

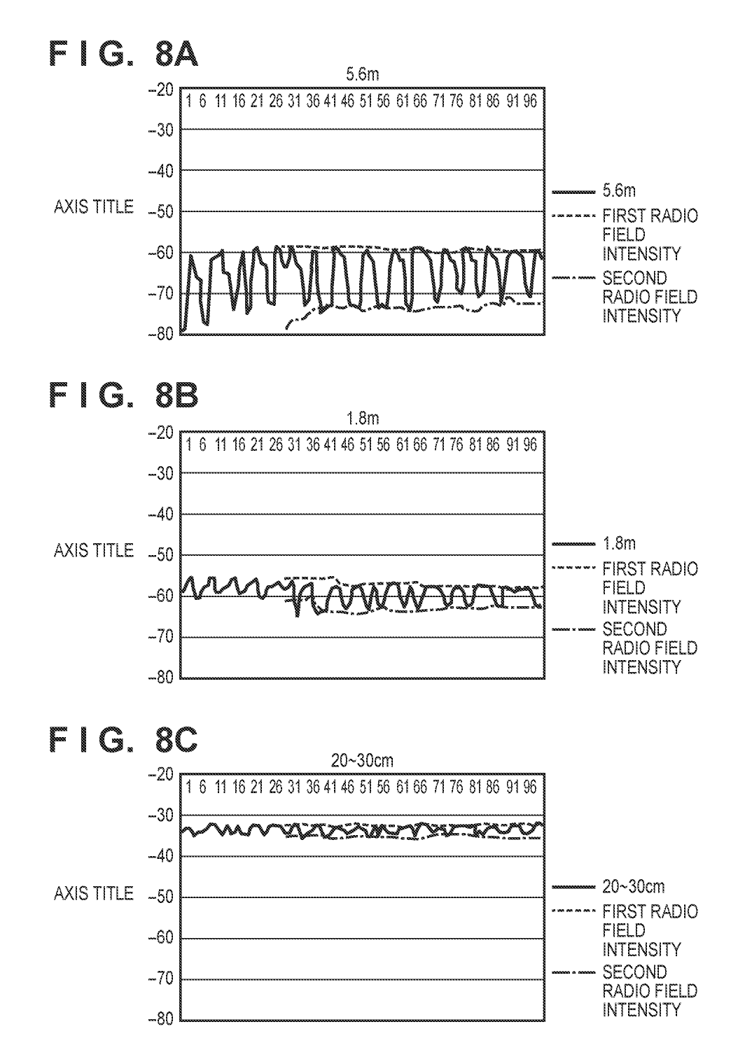

With reference to FIGS. 8A to 8C, the following describes the reason why an accurate distance can be obtained from the average value of radio field intensities included in a range with received radio waves having high radio field intensities and the average value of radio field intensities included in a range with received radio waves having low radio field intensities.

FIGS. 8A to 8C depict views showing examples of relationships between distances from the mobile terminal according to the first embodiment to an apparatus (herein, an image forming apparatus) that emitted radio waves and the first and second radio field intensities.

While a distance between the mobile terminal 130 and the image forming apparatus is determined based on the radio field intensities of radio waves received by the mobile terminal 130 as described above, experiments have proven that the extent of variations in the radio field intensities of received radio waves depends on the distance between the mobile terminal 130 and the image forming apparatus.

For example, FIG. 8A shows radio field intensities that were actually obtained through 100 reception of radio waves in step S704 of FIG. 7 when the distance between the mobile terminal 130 and the image forming apparatus was 5.6 m. In this case, the difference between high and low radio field intensities, that is, the difference between the first and second radio field intensities, is approximately 20 dBm at most.

FIG. 8B shows radio field intensities that were actually obtained through 100 reception of radio waves in step S704 of FIG. 7 when the distance between the mobile terminal 130 and the image forming apparatus was 1.8 m. When the distance is shorter as in this case, the difference between high and low radio field intensities, that is, the difference between the first and second radio field intensities, has a small value of approximately 10 dBm.

FIG. 8C shows radio field intensities that were actually obtained through 100 reception of radio waves in step S704 of FIG. 7 when the distance between the mobile terminal 130 and the image forming apparatus was 20 cm to 30 cm. When the distance is much shorter as in this case, the difference between high and low radio field intensities, that is, the difference between the first and second radio field intensities, has a small value of approximately 3 dBm.

In a case that the distance between the mobile terminal 130 and the image forming apparatus is somewhat long, high radio field intensities differ from low radio field intensities. Accordingly, as shown in the flowchart of FIG. 7, the first and second radio field intensities are obtained, and the distance is obtained based on these radio field intensities.

On the other hand, in a case that the distance between the mobile terminal 130 and the image forming apparatus is short, high radio field intensities hardly differ from low radio field intensities. Accordingly, it is unnecessary to calculate both the first radio field intensity and the second radio field intensity. Therefore, in a case that the mobile terminal 130 and the image forming apparatus are within an immediate range of each other, for example, only the first radio field intensity (the average value of a range with high radio field intensities) may be obtained, and the distance between the mobile terminal 130 and the apparatus emitting radio waves may be obtained based on the first radio field intensity.

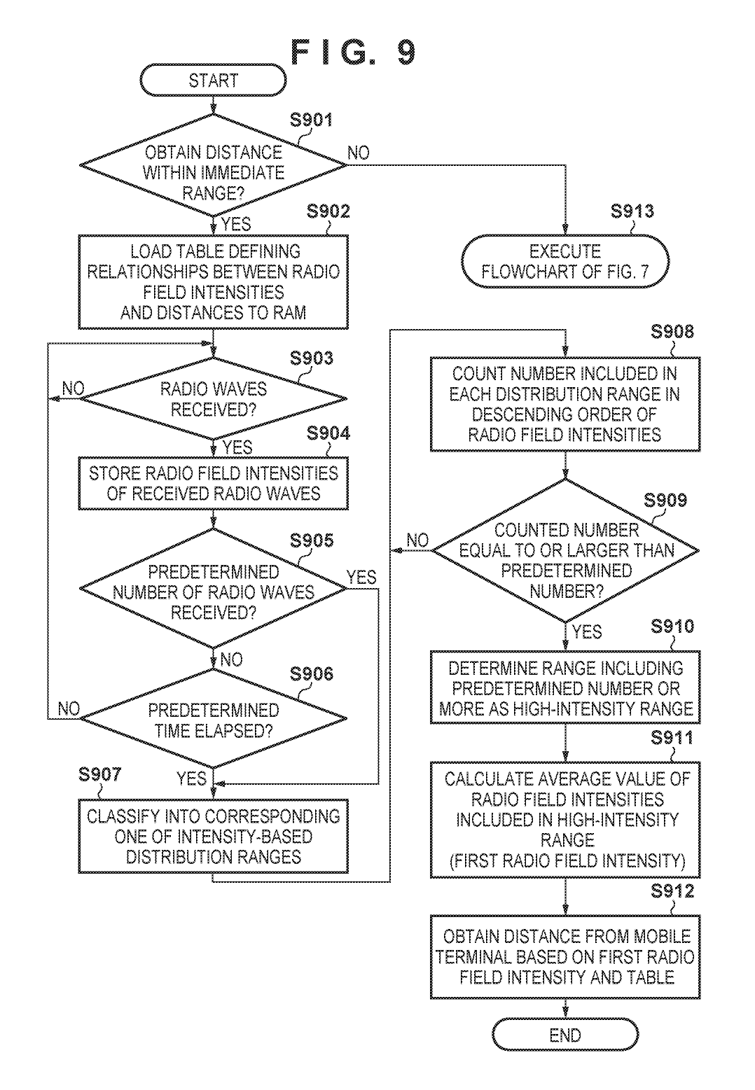

FIG. 9 is a flowchart for describing processing in which the mobile terminal 130 according to the first embodiment receives wireless radio waves emitted by an external apparatus that is within a close range thereof, and obtains a distance to the external apparatus based on their radio field intensities. A program that causes the CPU 301 to execute the processing of this flowchart is stored in the ROM 302 or the HDD 304, and the processing is implemented by the CPU 301 deploying the program to the RAM 303 and executing the deployed program.

Note that the mobile terminal 130 transmits E-mail addresses, image data, and the like to the image forming apparatus 100 when they are within such an immediate range of each other. In this case, as data needs to be accurately transmitted to the desired image forming apparatus 100, communication is performed only within an immediate range of 20 cm to 30 cm to prevent erroneous transmission as shown in FIG. 5A.

First, in step S901, the CPU 301 determines whether it is to obtain a distance within an immediate range. This determination is made, for example, based on whether an instruction for transferring image data to the image forming apparatus 100 has been issued on an operation screen of the mobile terminal 130.

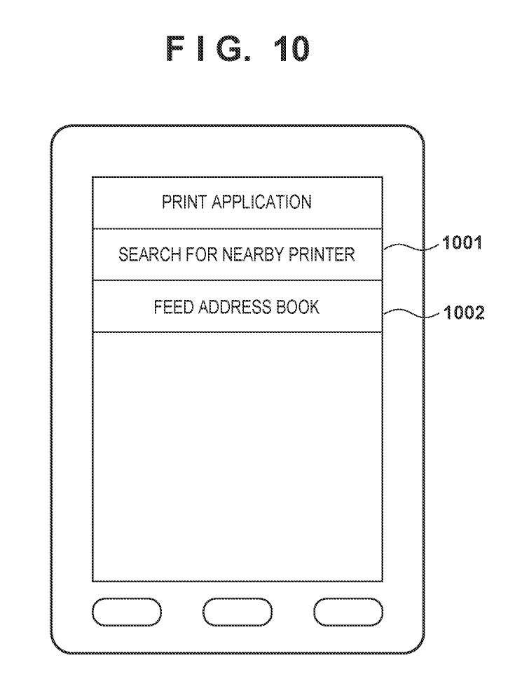

FIG. 10 depicts a view illustrating an example of a menu screen displayed on the operation unit 308 of the mobile terminal 130 according to the first embodiment.

A button 1001 is used to issue an instruction for searching for a nearby image forming apparatus (e.g., FIG. 5B). A button 1002 is used to issue an instruction for feeding address book data to an image forming apparatus (e.g., FIG. 5A). Therefore, in step S901, it is not determined that the distance is to be obtained within an immediate range if the button 1001 has been selected on the mobile terminal 130, and it is determined that the distance is to be obtained within an immediate range if the button 1002 has been selected on the mobile terminal 130. Note that information of the button selected on this screen is stored in the RAM 303.

In the case of operation within an immediate range, the processing proceeds from step S901 to step S902, otherwise, the processing proceeds to step S913. In step S913, the aforementioned processing of FIG. 7 is executed to specify the distance between the mobile terminal 130 and the image forming apparatus.

In step S902, the CPU 301 loads the table defining relationships between radio field intensities and distances, which is stored in the ROM 302 or the HDD 304, to the RAM 303 similarly to step S701 of FIG. 7. Note that this process of loading the table to the RAM 303 is unnecessary if, for example, the table is stored in the ROM 302 when referenced. Next, the processing proceeds to step S903 and the CPU 301 determines whether or not wireless radio waves have been received from an external apparatus. If the wireless radio waves have been received, the processing proceeds to step S904 and the CPU 301 stores their radio field intensities in the RAM 303. Next, the processing proceeds to step S905 and the CPU 301 determines whether or not the number of radio field intensities thus stored has reached a predetermined number necessary for obtaining a distance. It will be assumed herein that the predetermined number is 30, for example. If the CPU 301 determines in step S905 that it has not stored the predetermined number of radio field intensities of received radio waves, the processing proceeds to step S906 and the CPU 301 determines whether or not a predetermined time period (e.g., 30 seconds) has elapsed since the start of the processing of FIG. 9. To make this determination, the time is clocked by the aforementioned timer 309. If it is determined that the predetermined time period has elapsed, the processing proceeds to step S907, if not, the processing proceeds to step S903. The process of step S906 is intended to prevent an extreme delay in the processing of the mobile terminal 130 caused when the time taken to store the predetermined number of radio field intensities exceeds the predetermined time period.

If the CPU 301 determines in step S905 that the predetermined number of radio field intensities have been stored, or determines in step S906 that the predetermined time period has elapsed, the processing proceeds to step S907 and the CPU 301 classifies each of the radio field intensities of received radio waves into a corresponding one of intensity-based distribution ranges. This classification into distribution ranges can be performed by, for example, classifying standard deviations 3σ to −3σ in increments of 0.5σ. Next, the processing proceeds to step S908 and the CPU 301 counts the number of radio waves included in each distribution range, starting with a distribution range with highest radio field intensities. Then, the processing proceeds to step S909 and the CPU 301 determines whether or not the counted number is equal to or larger than a predetermined number (e.g., three). If the counted number is not equal to or larger than the predetermined number, the processing proceeds to step S908 to count the number of radio field intensities included in a distribution range with next highest radio field intensities, and then proceeds to step S909. If the counted number of radio field intensities included in the distribution range is equal to or larger than the predetermined number in step S909, the processing proceeds to step S910, and the CPU 301 determines that this distribution range is a range with high radio field intensities, and the processing proceeds to step S911. In step S911, the CPU 301 calculates an average value of the radio field intensities included in this distribution range, and uses the calculated average value as a first radio field intensity. Next, the processing proceeds to step S912 and the CPU 301 obtains a distance between the mobile terminal 130 and the apparatus (herein, the image forming apparatus) that emitted wireless radio waves with reference to the first radio field intensity obtained in step S911 and the table loaded to the RAM 303 in step S902. Thereafter, the present processing is ended.

As described above, when the mobile terminal 130 according to the first embodiment is to obtain a distance to an external apparatus that emitted radio waves within an immediate range of the mobile terminal 130, the mobile terminal 130 specifies the distance based on the average value of radio field intensities included in a range with received radio waves having high radio field intensities. In this way, a distance between the mobile terminal and the apparatus that emitted radio waves can be obtained accurately at higher speed.

The distance may be obtained based on an average value of radio field intensities included in a range with received radio waves having low radio field intensities, rather than the average value of radio field intensities included in a range with received radio waves having high radio field intensities.

### Second Embodiment

The foregoing first embodiment has introduced an example in which a distance between the mobile terminal 130 and the image forming apparatus 100 is specified by obtaining a predetermined number of radio field intensities necessary for specifying the distance. In contrast, a second embodiment introduces an example of a measure taken when the number of radio field intensities obtained within a predetermined time period falls below the number necessary for specifying the distance. Note that a mobile terminal 130, an image forming apparatus 100, a system configuration, and so forth according to the second embodiment are the same as their counterparts in the foregoing first embodiment, and thus a description thereof is omitted.

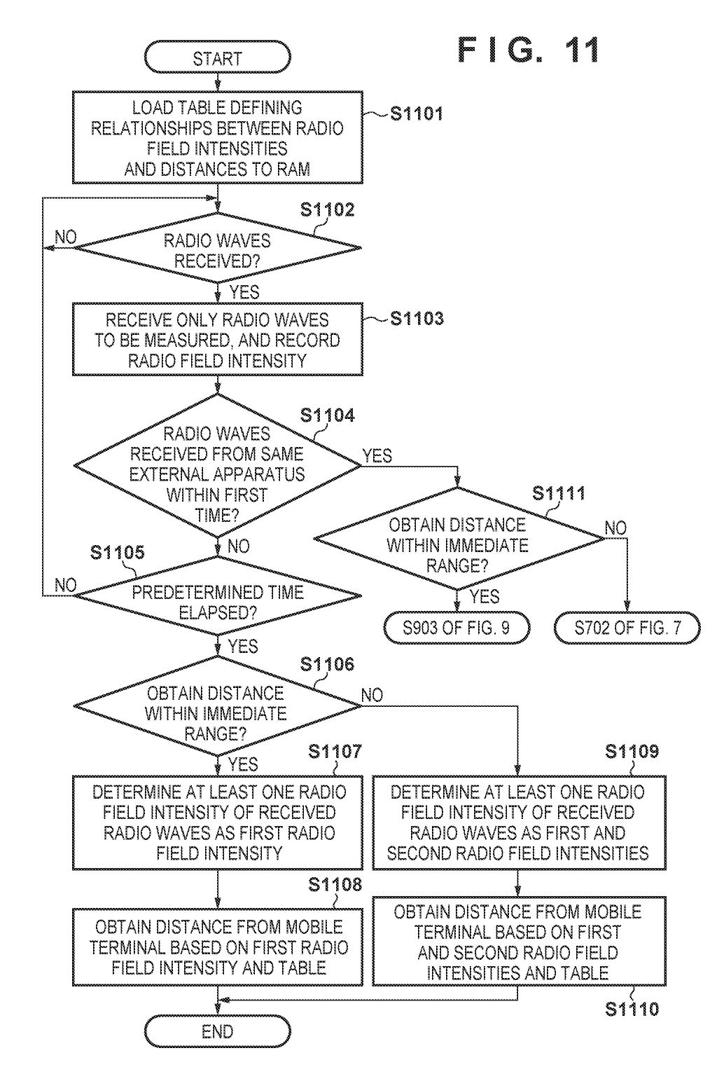

FIG. 11 is a flowchart for describing processing in which the mobile terminal 130 according to the second embodiment of the present invention receives wireless radio waves emitted by an external apparatus (herein, an image forming apparatus) and obtains a distance to the external apparatus based on their radio field intensities. A program that causes the CPU 301 to execute the processing of this flowchart is stored in the ROM 302 or the HDD 304, and the processing is implemented by the CPU 301 deploying the program to the RAM 303 and executing the deployed program.

First, in step S1101, the CPU 301 loads the table defining relationships between radio field intensities and distances, which is stored in the ROM 302 or the HDD 304, to the RAM 303 similarly to step S701 of FIG. 7. Next, the processing proceeds to step S1102 and the CPU 301 determines whether or not wireless radio waves have been received from an external apparatus. If it determined in step S1102 that the wireless radio waves have been received, the processing proceeds to step S1103. In step S1103, the CPU 301 stores a radio field intensity of the received radio waves in the RAM 303. Next, the processing proceeds to step S1104 and the CPU 301 determines whether or not radio waves have been received again from the same image forming apparatus within a first time period. It will be assumed herein that the first time period is 100 ms, for example. If it is determined that radio waves have been received from the same image forming apparatus, the processing proceeds to step S1111 to determine whether the processing is intended to specify a distance within an immediate range similarly to step S901 of FIG. 9, if so, the processes of step S903 and subsequent steps of FIG. 9 are executed. On the other hand, if it is determined in step S1111 that the processing is not intended to specify a distance within an immediate range, the processing proceeds to step S702 of FIG. 7.

If the CPU 301 determines in step S1104 that radio waves have not been received from the same image forming apparatus, the processing proceeds to step S1105 and the CPU 301 determines whether or not a predetermined time period has elapsed since the start of the processing similarly to step S906 of FIG. 9. On the other hand, if the CPU 301 determines in step S1104 that radio waves have been received from the same image forming apparatus, the processing proceeds to step S1111 and the CPU 301 executes the aforementioned process thereof. If the CPU 301 determines in step S1105 that the predetermined time period has elapsed, the processing proceeds to step S1106, if not, the processing proceeds to step S1102.

In step S1106, the CPU 301 determines whether or not the processing is intended to specify a distance within an immediate range similarly to step S901 of FIG. 9, if so, the processing proceeds to step S1107, and if not, the processing proceeds to step S1109. In step S1107, the CPU 301 determines one radio field intensity of the received radio waves as a first radio field intensity. Then, the processing proceeds to step S1108 and the CPU 301 specifies a distance between the mobile terminal 130 and the external apparatus (image forming apparatus) that emitted wireless radio waves from the first radio field intensity and the table loaded in step S1101, thereafter, the present processing is ended.

On the other hand, in step S1109, the CPU 301 determines one radio field intensity of the received radio waves as a first radio field intensity and a second radio field intensity. Then, the processing proceeds to step S1110 and the CPU 301 obtains a distance between the mobile terminal 130 and the apparatus (image forming apparatus) that emitted wireless radio waves from the first radio field intensity, the second radio field intensity, and the table loaded in step S1101, thereafter, the present processing is ended.

As described above, in the second embodiment, a distance between the mobile terminal 130 and the external apparatus that emitted radio waves can be specified even when the number of radio field intensities obtained within a predetermined time period falls below the number necessary for specifying the distance.

### Other Embodiment

Embodiments of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiments and/or that includes one or more circuits (e.g., application specific integrated circuit (ASIC)) for performing the functions of one or more of the above-described embodiments, and by a method performed by the computer of the system or apparatus by, for example, reading out and executing the computer executable instructions from the storage medium to perform the functions of one or more of the above-described embodiments and/or controlling the one or more circuits to perform the functions of one or more of the above-described embodiments. The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2016-060903, filed Mar. 24, 2016, which is hereby incorporated by reference herein in its entirety.

What is claimed is:

1. A communication apparatus, comprising:
a memory device that stores a set of instructions; and
at least one processor that executes the instructions to:
hold a table defining relationships between radio field intensities of radio waves received from an external apparatus and distances to the external apparatus,
store radio field intensities of radio waves received from the external apparatus in a memory,
calculate at least a first radio field intensity and a second radio field intensity from the radio field intensities stored in the memory, and
obtain a distance to the external apparatus based on the table and one or both of the first radio field intensity and the second radio field intensity,
wherein in the calculation, the first radio field intensity and the second radio field intensity are respectively calculated as representative values of high radio field intensities and low radio field intensities included among the radio field intensities stored in the memory.

2. The communication apparatus according to claim 1,
wherein in the calculation, an average value of a predetermined number or more of radio field intensities included in a distribution range of the high radio field intensities is calculated and used as the first radio field intensity.

3. The communication apparatus according to claim 1,
wherein in the calculation, an average value of a predetermined number or more of radio field intensities included in a distribution range of the low radio field intensities is calculated and used as the second radio field intensity.

4. The communication apparatus according to claim 2,
wherein distribution ranges of radio field intensities are obtained from deviations of radio field intensities of received radio waves.

5. The communication apparatus according to claim 1,
wherein the obtainment of the distance to the external apparatus is performed based on the table and one of the first radio field intensity and the second radio field intensity in a case that the distance to the external apparatus is within a specific range.

6. The communication apparatus according to claim 5,
wherein the at least one processor executes the instructions to further indicate whether or not the distance to the external apparatus is within the specific range, and in the obtainment, whether the distance to the external apparatus is within the specific range is determined in accordance with the indication.

7. The communication apparatus according to claim 2, further comprising:
a timer that clocks a time period,
wherein in a case that the predetermined number or more of radio field intensities are not stored to the memory within a predetermined time period clocked by the timer, at least one or more radio field intensities of radio waves that have been received up to the time period are used as the first radio field intensity and the second radio field intensity in the calculation.

8. The communication apparatus according to claim 2, further comprising:
a timer that clocks a time period,
wherein in a case that the predetermined number or more of radio field intensities are not stored to the memory within a predetermined time period clocked by the timer, at least one or more radio field intensities of radio waves that have been received up to the time period are used as the first radio field intensity in the calculation.

9. A method of controlling a communication apparatus that specifies a distance to an external apparatus based on radio field intensities of radio waves received from the external apparatus, the method comprising:
storing radio field intensities of radio waves received from the external apparatus in a memory;
calculating at least a first radio field intensity and a second radio field intensity from the radio field intensities stored in the memory; and
obtaining the distance to the external apparatus based on a table and one or both of the first radio field intensity and the second radio field intensity, the table defining relationships between radio field intensities of received radio waves and distances,
wherein in the calculating, the first radio field intensity and the second radio field intensity are respectively calculated as representative values of high radio field intensities and low radio field intensities included among the radio field intensities stored in the memory.

10. The method according to claim 9,
wherein in the calculating, an average value of a predetermined number or more of radio field intensities included in a distribution range of the high radio field intensities is calculated and used as the first radio field intensity.

11. The method according to claim 9,
wherein in the calculating, an average value of a predetermined number or more of radio field intensities included in a distribution range of the low radio field intensities is calculated and used as the second radio field intensity.

12. The method according to claim 10,
wherein distribution ranges of radio field intensities are obtained from deviations of radio field intensities of received radio waves.

13. The method according to claim 9,
wherein the obtaining of the distance to the external apparatus is performed based on the table and one of the first radio field intensity and the second radio field intensity in a case that the distance to the external apparatus is within a specific range.

14. The method according to claim 13, further comprising:
indicating whether the distance to the external apparatus is within the specific range,
wherein in the obtaining, whether the distance to the external apparatus is within the specific range is determined in accordance with the indication.

15. The method according to claim 10, further comprising:
clocking a time period,
wherein in a case that the predetermined number or more of radio field intensities are not stored to the memory within a predetermined time period clocked in the clocking, at least one or more radio field intensities of radio waves that have been received up to the time period are used as the first radio field intensity and the second radio field intensity in the calculating.

16. The method according to claim 10, further comprising:
clocking a time period,
wherein in a case that the predetermined number or more of radio field intensities are not stored to the memory within a predetermined time period clocked in the clocking, at least one or more radio field intensities of radio waves that have been received up to the time period are used as the first radio field intensity in the calculating.

17. A non-transitory computer readable storage medium storing a program for causing a processor to execute a method of controlling a communication apparatus that specifies a distance to an external apparatus based on radio field intensities of radio waves received from the external apparatus, the method comprising:
storing radio field intensities of radio waves received from the external apparatus in a memory;
calculating at least a first radio field intensity and a second radio field intensity from the radio field intensities stored in the memory; and
obtaining the distance to the external apparatus based on a table and one or both of the first radio field intensity and the second radio field intensity, the table defining relationships between radio field intensities of received radio waves and distances,
wherein in the calculating, the first radio field intensity and the second radio field intensity are respectively calculated as representative values of high radio field intensities and low radio field intensities included among the radio field intensities stored in the memory.
